(19) United States
(12) Patent Application Publication
(10) Pub. No.: US 2026/0335767 A1
(43) Pub. Date: Oct. 29, 2026

(54) High-Definition American Football Video game

(71) Applicants: ronaldo cordero navarro, hacienda hts, CA (US); Jocelyn Co, Chino, CA (US)

(72) Inventors: ronaldo cordero navarro, hacienda hts, CA (US); Jocelyn Co, Chino, CA (US)

(21) Appl. No.: 19/697,624

(22) Filed: Jun. 4, 2026

Related U.S. Application Data
(63) Continuation-in-part of application No. 18/326,958, filed on May 31, 2023.

(51) Int. Cl. A63F 13/56; A63F 13/497; A63F 13/52; A63F 13/67; A63F 13/812; G09B 7/06

(52) U.S. Cl. CPC A63F 13/56; A63F 13/497; A63F 13/52; A63F 13/67; A63F 13/812; G09B 7/06

(57) ABSTRACT

While entertainment grade video games thrive in an ever-growing video game market, video games that focus on learning maintain their intrinsic value in terms of intellect and knowledge. Target players for educational games do not often represent the mainstream population of gamers, and vice versa. Bridging such gap may present the risks of diluting the commercial appeal of highly popular game titles. Real-time rendering, the natural partner of popular games, remains a burden on computational resource budgeting. This project proposes to mitigate animation detailing to accentuate the sports simulation video game of American Football with fluid lifelike motions by utilizing objective assessment structure for game control to combine competition, education, and gaming entertainment.

### RELATED U.S. APPLICATION DATA CONTINUATION-IN-PART APPLICATION

This application is a continuation-in-part of U.S. patent application Ser. No. 18/326,958, filed May 31, 2023, which is currently pending, the entire disclosure of which is incorporated herein by reference.

### BACKGROUND

### Field of Invention

The various aspects discussed herein relate to a sports-simulation video game.

### Description of Related Art

Primary intrinsic motivation and value of sports simulation video games center on the context of entertainment. However, there are problems with said sports-simulation video games.

### BRIEF SUMMARY OF THE INVENTION

The popularity of video games reflect a huge industry. Open Science Data indicates its intrinsic value equating predominantly to entertainment. This disclosure proposes to leverage aspects described herein along with the pronounced commercial appeal of video games to present a type of sports-simulated video game that could potentially address broader impacts.

In aspects described herein, a high-definition sports simulation game is disclosed. The high definition sports-simulation game may have a process of adapting the characteristics of the game of American football as preferred embodiment of said sports simulation video game, a process for enabling one or more users, a library of scripted prerendered animated gameplays, a process for pre-game settings, a control implement, a process for category selection, a process for triggering specific gameplay playback, game controlling device, and an educational implement.

With respect to the process for enabling number of user(s), the selection for one user would configure the game session for said user to compete against the computer, while the selection for more than one user would configure the game session for competition between the participating users.

The gameplay library may contain a collection of scripted pre-rendered gameplays that may be produced from techniques that are not subject to constraints of real-time rendering, enabling said pre-rendering technique to feature necessary graphical animation variables in effecting fluid life-like motion representation of said gameplays. The gameplays may be additionally organized by a collection of categories, whereby each category from said collection of categories may represent variations of gameplay outcomes depicting specific net yardage and whereby the categories may range from −99 yards, or maximum yardage that can be lost, to 100 yards, or the maximum yardage that can be gained, respectively on any one given play. Additionally, the gameplays may be represented with respective pre-scripted text-to-speech content to depict voice-over narration per respective said gameplays, whereby said pre-scripted text-to-speech content may contain variable spaces reserved to correspond with values per said user(s) inputs per pre-game setup, per game session.

The pregame settings may prompt or enable said user or users to input pre-game selection settings for purposes of game setup that may include, but not limited to, 3d character characteristics or properties, respective uniforms of said 3d characters, uniform numbers of said respective uniforms and may additionally include said user(s) input of names for specific 3d characters that are associated with game-defined positions associated with ball handling such as quarterback, running back, receivers, intended to fit respective voice-over narration per respective gameplay contained in said library.

The control implement may feature an objective assessment format with a stem question and at least one correct answer and at least one plausible alternative, with said control implement recurring with a different display of context at stoppage of every gameplay per gaming session.

The process for category selection may prompt or enable competing users for consentaneous selection of a subject category coordinated with an objective assessment format characterized by Multiple-Choice-Question structure, whereby categories and content may include educational content for fostering learning.

The process for triggering playback of gameplays may involve assessment, evaluation and weighing of answers per instance of said objective assessment, taking into account, answer correctness, answer completeness, promptitude, current field position, and respective quantification of said answers with relation to correctness and/or incorrectness of said answers, with the resulting gameplay being commensurate to the score differential, whereby the bigger the difference, the bigger the net yardage to be depicted in respective gameplay wherein the maximum difference may be equated with up to 100 yards, which could further translate to a possible net yardage ranging from 100 yards, or maximum yardage that could be gained, to −99 yards, or maximum yardage that could be lost, as respective of commensurate depiction.

The controller(s) may be wired devices or wireless devices as interface that said user(s) may utilize for facilitation of said control implement and submit inputs.

With respect to the educational implement, said implement may enable user(s) for input towards objective assessment questions that foster learning

Effecting the spontaneous characteristics of viewing a live football game by means of combined realistic animation with a controlling element, defining it as a game, and with the controlling element representative of an educational implement, a commercial appeal of an educational video game may be established.

### BRIEF DESCRIPTION OF THE DRAWINGS

FIG. 1A depicts a partial view of one embodiment of the system in which aspects involved with the game's linear game flow is illustrated

FIG. 1B depicts the accompanying partial view of the same embodiment of the system in which additional aspects involved with the game's linear game flow is illustrated.

FIG. 2 lists processes involved in the animation rendering/game settings/general directory details. FIG. 3 thru FIG. 5 depict the system flowchart.

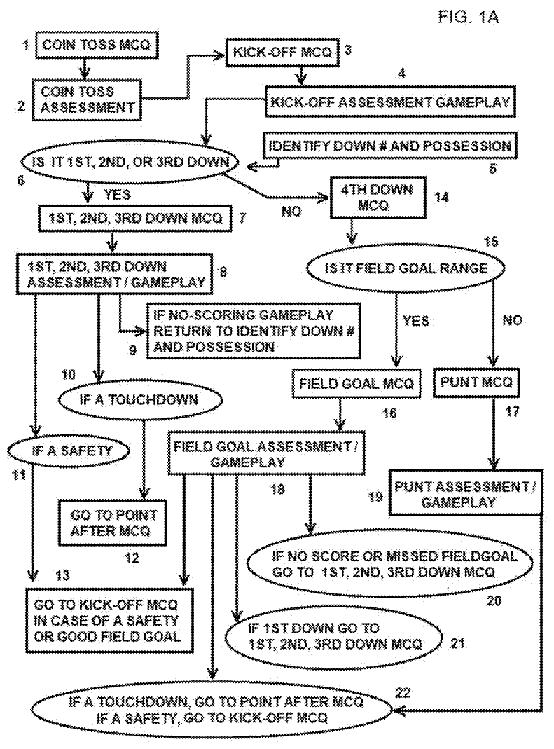

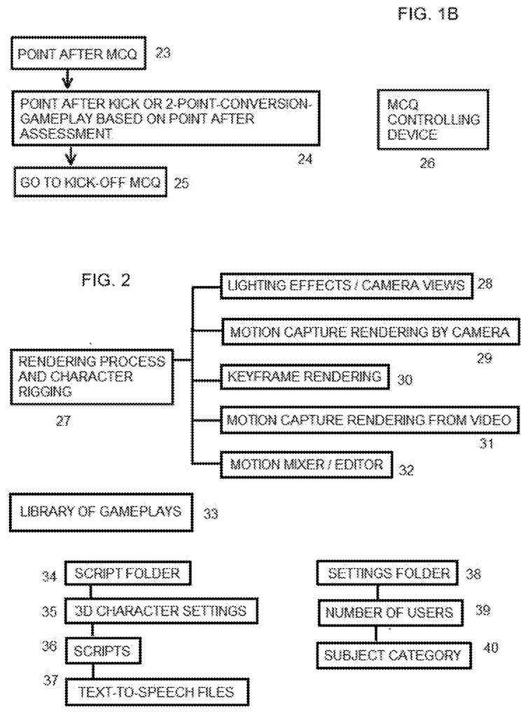

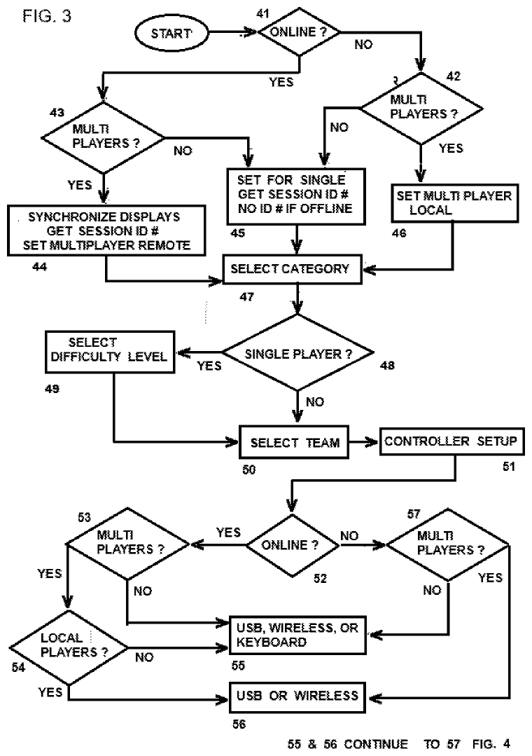

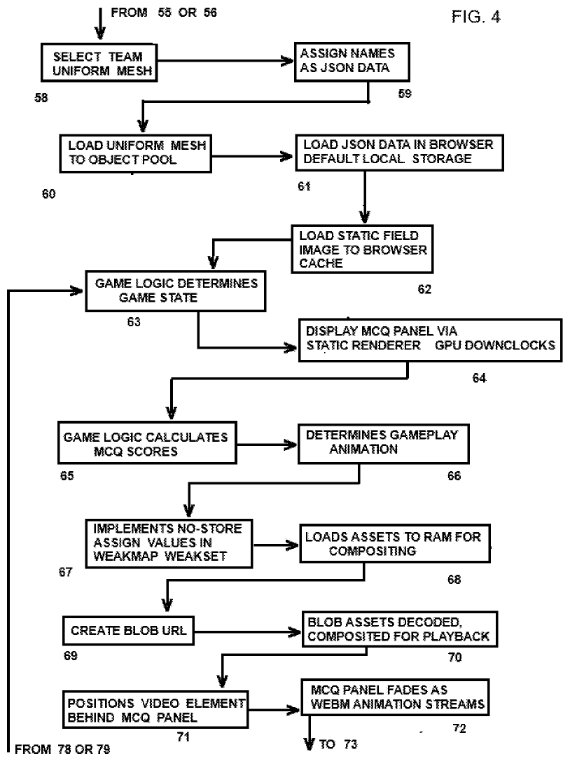

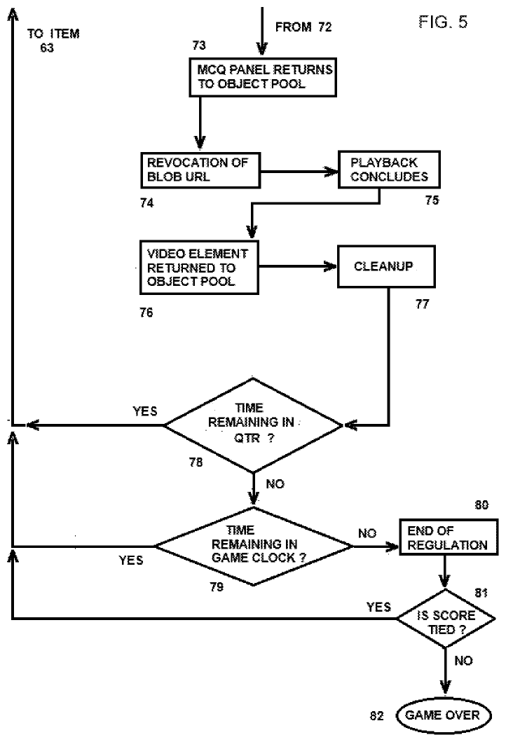

### DETAILED DESCRIPTION

Disciplines in animation popularly involve real-time rendering (for gaming engines) and scripted pre-rendered animation (for movie rendering engines). Gaming engines and rendering engines share the same principles involving creation of 3d animation characters. The use of skeletal structure fused with a 3d character wherein the framed 3d character movements are catalyzed by motion data mapped and synchronized with its skeletal structure.

However, their respective rendering processes contradict. Gaming software, especially sports simulation games, are mostly associated with real-time rendering in correlation to operation protocols that center on interactive input. Movie animation is associated with scripted prerendered animation in correlation to production of rich animation details not subject to real-time rendering constraints and benefiting from generous computational resource budgeting.

Game applications' inherent feature of user real-time interaction requires a real-time frame-by-frame rendering process for instantaneously interpreting user input that is intended to correlate or simulate human motion, especially sports-simulation games. This process is subject to constraints of real-time rendering with limited motion data for addressing technical risks of endless animation variables that are further compounded by variations from character to character, to represent realistic fluid gameplay scenes. These constraints effect with generalized motion interpretation due to limitation of motion profile references, and may resemble mechanical movements attributed to the technical risks associated with endless variations of animation variables.

Though simulations are compromised with mathematical impossibility effecting with generalized motion definitions and with representations of mechanical motion, resourceful computational resource budgeting by gaming engines' real-time rendering structure contributes pronouncedly to incremental and non-incremental innovations in real-time animation.

Without constraints of real-time rendering, movie animations benefit with high levels of details from the necessary animation variables to lighting effects and clothing details in depicting fluid animation and realistic scenes. Sports simulation video games aspire to featuring as much details as possible with frame-by-frame interaction, but scripted pre-rendered animation suggest a mismatched proposition concerning real-time controls and interaction.

Lifelike motion may not be for every video game, but the genre of sports simulation video games, and sports simulation video games depicting the game of Professional American Football could benefit from animation optimization depicting fluid motion that is possible with scripted pre-rendered animation. Such effects could enhance its commercial appeal and further raise its entertainment intrinsic value. A controlling implement could be integrated or featured with the use of objective assessment format and represented prompts that, hereinafter referred to as MCQ (for Multiple Choice Question Format) is not reliant on frame-by-frame interaction. Furthermore, an objective assessment format such as said MCQ as a control implement could be leveraged to being an educational tool by featuring educational content. This could effect with an elevated intrinsic value that addresses broader impacts.

With commercial appeal of professional sports as represented by sports simulation video games, especially games representing American Football, disclosed herein are aspects of a high-definition sports simulation video game, hereinafter referred to as video game, representing American Football that proposes a departure from required dexterity of physical means of operation involving hand-eye coordination. And instead, with suggestion of direction and control of game flow involving said video game by means of intellectual dexterity through the use of educational content in conjunction with said mcq format, to potentially serve as leverage in accentuating a popular sport.

Said MCQ format as controlling implement may be operated and represented by either wired controlling devices or wireless devices over a client-server application. Additionally, said video game may be operated on a multi-player or multi-user setting that would enable representation of multiple players per team, per game session, through consentaneous aggregation of respective answers.

Aspects of animation process for creation of scripted pre-rendered gameplays may include: Character Rigging 27, which is the method of creating a “skeleton” for a 3D model to be manipulated and animated when integrated with motion data or motion capture data. It involves graphical setup that enables definition of range of movements of joint areas from head to toe.

Motion Capture by Keyframing 30, which denotes starting frame and ending frame of projected motion, whereby respective motion per 3d character is defined as logical sequences of keyframes that are graphically set, whereby interpolation values between keyframes, for correlating time and speed are digitally generated to automatically define the frames within the key frames, intended of translating into smoothness between the respective start and end frames.

Motion Capture (markerless) by Camera 29, the process of recording or capturing movements by camera and without physical marker sensors, of one or more subjects which are translated into motion data can be merged into said skeleton structure, and enabling animation, for respective 3d Characters.

Motion Capture (markerless) from video 31, the process of recording or capturing movements from reference video footage, of at least one subject and translates into motion data that can be merged into said skeleton structure, and enabling animation, for respective 3d Characters.

To depict natural fluid motion, gameplays may be replicated from reference footage representing authentic motion involved in football. Motion data may be replicated by keyframe rendering 30 on a per character basis from reference footage imported into respective 3d characters, and later merged with other characters into gameplay scenes.

Motion data captured by camera 29 from live action may be retargeted or fused into respective 3d characters to translate into animation involving single or multiple characters at a time for assembly into a complete gameplay scene with the live action as basis of reference. Motion data captured by camera 29 from live action may also be used to replicate a documented reference footage depicting authentic motion.

Regarding said video game, the aforementioned aspects 27 thru 32, may be utilized in any combination to serve as essential tools in creating high fidelity animation gameplays replicated from reference footage with authentic motion while abstracting out the least essential details when necessary, to mitigate computational resource budgeting, per gameplay, with emphasis on presenting optimum motion fidelity. Additionally, gameplay rendering processes may include lighting effects, and different camera views for further graphical enhancement or optimization.

For efficient production and editing of motion capture data, motion capture data may be recycled and edited into new definitions as necessary for replication of video reference footages. For further editing versatility, a motion mixer/editor 32 may be used to mix motion capture data. The concept of the Motion Mixer is based on audio mixing done in the music and sound editing. Like an audio mixer, Motion Mixer lets you add a series of tracks for each object or 3d character in a scene. Even filtering processes are available for smooth linking of motion capture data.

As the rendering technique involves a layered process with creation of gameplays independent of background and middle ground assets such as the graphical display of the playing field, the game algorithm upon playback trigger, pans the graphical representation of the playing field to merge respective gameplay to the active field position.

Highlighting the professional sport of American football involving its features include: A playing field represented with 100 yards in length, with yard line markings, and goal posts at each end zone; Participated by two opposing teams whose respective goals are to score the higher points through touchdowns, field goals, safeties, 2-point conversions and extra points after touchdown; The 2 teams with cyclical and alternating roles depicting offense and defense; With the rule that enables the team with possession of the ball of scoring opportunity, the offensive team, being the team with ball possession aiming to advance towards the opponent's end zone with the aim of the defense of countering while also aiming to take possession of the ball; The offensive team having 4 downs or plays to score or advance at least 10 yards to renew another series of 4 downs; Playing duration of 60 minutes distributed in 4 quarters with respective alternating ball possession assignments per half or 2 quarters; And with continuous game clock only interrupted by penalty calls, timeouts, out-of-bounds plays, ball possession change; And gameplay clock that runs for 40 seconds after every stoppage.

Participating players involved with said sports simulation video game would be referred to, hereinafter, as user and/or users.

The algorithm and rendering techniques supported by said video game translates the rules, features, and characteristics of the sport of American Football into a high-fidelity animated game without the predictability of interactive control, to simulate a live game viewing environment.

Although the game algorithm and library of scripted pre-rendered gameplays combine to provide capacity of presenting gameplays that involve net yardage of −99 to 100 yards and combinations in between, probability and outcome per mcq cycle are influenced and controlled by users' mcq answering proficiency. Computational definitions factor respective users' mcq responses, taking into account mcq answer correctness, mcq answer completeness, mcq retracing, and promptitude (relating to the time limit of 40 seconds per mcq set), scoring differences, and current field position to determine and trigger a commensurate gameplay.

The MCQ prompts serving as front end control implement interface 26 delivers and displays the stem questions in cyclical sets of 4 with each question stem respectively containing 4 answers, of which, at least 1 is the correct answer supplemented by plausible distractors or incorrect answers. Said MCQ prompts are represented in variations such as 4th Down MCQ 14, 1st 2nd 3rd Down MCQ 7, Field

Goal MCQ 16, Punt MCQ 17, Kick-off MCQ 3, and Point-After MCQ 23 to pre-define parameters analyzed by the game algorithm of said video game in determining the game flow and upcoming corresponding type of gameplay. Thus, when the game flow calls the 1st 2nd 3rd Down MCQ 7, it signals the algorithm that a kicking gameplay will not be included in the next computation in determining the type of gameplay, and so on.

With high-fidelity animation central to said video game's format, a library 38 of scripted pre-rendered gameplays, stored on the server executing said video game, would serve as reservoir from which the game would draw a specific gameplay warranted per algorithmic assessment of users' performance toward each set of respective mcq prompts, serving as the game's catalyst or controlling implement

Gameplays would be depicted categorically according to net yardage ranging from positive 100 yards to −99 yards. Whereby each category would entail variations for further representation of realism involved for simulating a live game view presentation.

As said gameplays are net yardage specific, depictions of gameplays with penalty situations would be factored in into said gameplays involving penalties for the purpose of presenting additional granular effects for simulating a live game presentation

As the scripted pre-rendered gameplays would be maintained in an ever expanding shared library whereby versions can be managed and updated by users and would maintain neutral properties in terms of uniform related characteristics subject to customization during run time, according to pre-game user-defined settings.

Aspects described herein illustrates the pre-game setup stored on the settings folder 38 for said video game.

A game session would involve a setup process that would prompt for the number of players 39. With the game of football featuring two opposing teams, in a setting involving multi-user setup, a team may be represented by a user or group of users. An opposing team may be represented by another user or group of users. A single user setup may involve a user or users to represent one team, while the computer would represent the opposing team. With single player setting, additional setting for selecting values for level of difficulty would represent the levels for: Easy; Moderate; and Challenging. In reflecting these modes, the computer performance levels, with respect to the mcq feature serving as controlling implement, would represent the average score generation of 40% 70%, and 90%, to correspond to the levels of Easy, Moderate, and Challenging, respectively.

The pre-game setup for character settings 35 or properties may include: selection of uniforms and numbering details; and characteristics. These settings are stored in the script folder 34 for their dynamic properties, instead of the settings folder 38, used for static settings.

Additional pre-game setup 35 involves name assignments and respective positions for 3d characters representing playing positions that are associated with ball handling for the purpose of value assignment to variables in text-to-speech 37 content for accompanying voice over narration per scripted gameplay.

Further pre-game setup involves selecting a subject or topic category 45 whose respective context would be represented in the game session's mcq prompts.

With the cyclical structure involving mcq prompts recurring at every game stoppage or conclusion of a gameplay, one representation of an algorithm flow involved in assessing mcq score, herein, is illustrated.

MCQ prompts would be cyclical and would activate at every game stoppage to provide direction. Each mcq set would feature 4 stem questions with 4 answers per set, whereby each answer set would have at least 1 correct answer and at least 1 plausible distractor. With 4 stem questions per cycle, and 4 answers, of which at least one is correct, points toward an mcq score per user are distributed according to performance, evaluating answer correctness, answer completeness, promptitude, differential and answer retracements, per cycle involving 40 seconds.

### Answer Correctness

Each correct answer I point
Each incorrect answer −I point

### Score Differential

where there is a difference:
difference of 1 would count as 1 point for the user with most correct answers;
a positive difference of 2 would count as 3 points for said user with most correct answers;
a positive difference of 3 would count as 20 points for said user with most correct answers;
a positive difference of 4 would count as 100 points for said user with most correct answers;
the user with less correct answers does not get differential point credit.

### Promptitude

Total time per user is the time until they submit their answers. Regardless, the gameplay does not activate until the 40 seconds expires. Maximum total time is 40.

Total time per user is assessed involving formula of (40−total time)/3 and rounded to the nearest whole number, with each second equating to 1 point. If there is a difference between each user's score, the lesser number is subtracted from the larger number. The difference, equates to promptitude points. The user with the larger number is credited with the promptitude points and added to that user's subtotal. The user with the lesser number receives no promptitude points.

### Retracement

Retracement per question=−I per incident

### Answer Completeness

unanswered question −I

The points are added and equated to yardage whereby 45 points=45 yards. Such case would involve a playback of a gameplay of 45 yards for either user. If the 45 yards are earned by the user representing the offense, a gameplay of +45 yards would result. Inversely, if the 45 yards are earned by the user representing the defense, a gameplay of −45 yards would result.

As each presentation of an mcq set is not reused per game session, a timeout would result in a new mcq set. Either team is entitled to use a timeout for respective strategies. In any case that the user representing the offense fails to submit their answers before the 40 second time limit expires and without calling a timeout, a gameplay representing a delay of game would be activated depicting the penalty, and the field position tracked. Variations of illustrated algorithm would be scaled to depict adjustments involving situations that statistically involve more yardage, such as kickoff and punting situations which usually involve more open field running. Adjustments may involve relaxing the promptitude equation eliminating the divisor.

Aspects described herein illustrates the game flow for said video game. Coin Toss mcq 1 and assessment 2, equates to a coin toss before start of a football game Enabling the winner to select their first role as an offensive team or defensive team.

Kickoff mcq 3 and assessment 4, determines net yardage for matching and selection of commensurate gameplay involve in a kick-off situation. The assessment algorithm identifies the respective offensive and defensive teams and computes and tracks the field position, down number, and game score, game clock, and timeouts. Algorithm-selected gameplay is loaded from the library folder 33, and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay is displayed.

If the current Down number analyzed in item 5 or 6, is identified by said game algorithm to be 1st, 2nd, or 3rd, the 1nd 2nd 3rd down mcq 7 is executed and displayed on the user's or users' control devices 26. Said 1st 2nd 3rd mcq 7 would be assessed 8 for a possible gameplay associated with the corresponding tracked Down number. As in the real game of football, results of possible net yardage per any given play could depict a gameplay ranging from an offensive or defensive touchdown score 10 or a defensive score 11, and net yardages in between. Item 8, assesses for possible results 9, 10, or 11, respective of the user's or users' mcq scores. Any resulting scoring gameplay would direct the game flow to the kickoff mcq 3 in case of safety, or directed by item 12 to point after mcq 31 in case of touchdown. If there is no scoring 9, the algorithm would track the Down number and possession 5 and direct the mcq flow to the 1st 2nd 3rd down mcq 7. Algorithm-selected commensurate gameplay 8 is loaded from the library folder 33 and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay 8 is displayed.

If the current Down number tracked by said game algorithm is 4, the 4th down mcq 14 is executed and displayed on the user's or users' control devices 26. Said 4th down mcq 14 would be assessed for a gameplay associated with possible 4th down plays. If in field goal range 15, mcq flow would direct to field goal mcq 16, which may flow to the field goal gameplay 18, or punt mcq 17, for possible flow to a punt gameplay 19. Possible offensive and defensive scoring, and all net yardage are analyzed, with outcome dependent on correlated and weighed assessment by the mcq scores to be translated into a commensurate gameplay. This may involve a missed field goal 20, a first down result 21 or a touchdown 22. Any resulting scoring gameplay, would direct the game flow to the kickoff mcq 3. All else would revert to the 1st 2nd 3rd down mcq 7 Algorithm-selected gameplay is loaded from the library folder and its associated script 36 from the script folder 34, executes to setup the neutral properties of the respective 3d characters in said gameplay to the respective user(s) defined character settings 35 including text-to-speech values 37 according to the properties set at pre-game. Said commensurate gameplay is displayed.

If previous gameplay resulted with a touchdown, the corresponding mcq 23 would display whose ensuing assessment would execute the algorithm accordingly, to display a commensurate gameplay 24 relating to the point after mcq 23. As with the other assessment variations depending on users' mcq scores, possible gameplays ranging from a 2-point conversion 24 by the offense to a 2-point score 24 by the defense are computed, accordingly and subject to the respective mcq assessment gameplay. Any resulting scoring gameplay 25, would direct the game flow to the kickoff mcq 3. All else would revert to the 1st 2nd 3rd down mcq 7. Commensurate gameplay is loaded from the library folder 33 and its associated script 36 from the script folder 34, executes to setup the neutral properties of the respective 3d characters in said gameplay to the respective user(s) defined character settings 35 including text-to-speech values 37, according to the properties set at pre-game Said commensurate gameplay is displayed.

The items illustrated in the respective drawing figures denote a linear flow of said video game. As any flow disruption affecting direction and ball possession could occur with any given play, as based on mcq scores, said game algorithm tracks ball possession, field position accordingly with each assessed mcq, and is able to direct game flow accordingly. As such, other details while executing playbacks of scripted gameplays, said game algorithm would direct the game flow to the Point After MCQ 31 (as due to touchdowns and scoring plays 10, 11), and/or Kick-off mcq 3 and 1st 2nd 3rd Down MCQ 7, accordingly, and as commensurate gameplays relative to mcq scores.

[NEW MATTER from paragraph 70 and all claims]

The animation file asset of said video game is rendered, stored, and streamed using a WebM file container format, encoded at 60 frames per second (fps), at a bitrate of 4 Mbps with a resolution of 720p, and with a frame size of 1280×720. Additional parameters of the WebM animation include straight alpha channel for necessary transparency involving the background and grayscaled character rigs (3d characters) for compositing with additional assets including uniform meshes, static football, and 3d full-length-scaled football field background contained in WebP file format.

The animations are rendered with the Computer Graphics Software, 3DS Max, contained in its native FBX file format with respective 60 fps parameter. The FBX animation files are then converted to image sequences in PNG file format with the respective 60 fps and resolution parameter of 720p. Then, the PNG file of sequenced images are encoded and converted to the Webm file format using a 2-pass FFmpeg process with the respective 60 fps, 720p resolution, and 4 mbps target bitrate parameters.

Respective of NFL football gameplays average duration of 5 to 8 seconds, said video game's parameter estimation high-budgets its average gameplay duration with an average duration of 10 seconds, for the purpose of adding contingency buffer, or protective estimate. Based on parameters of 60 fps, 720p resolution, 4 mbps target bitrate, and 10 second duration, the 2-pass ffmpeg encoding process, maintaining the straight alpha channel involving the vp9 codec, using libvpx with yuva420 pixrl format, and crf command option for efficiently allocating higher bit rate to complex scenes, while lower bit rate to simple scenes, the ffmpeg encoding yields an average compressed optimized file size of approximately 3

Each position in an average 11-player football team roster represented in an offensive unit is profiled with respective skeletal properties that include vertex data and real life metrics into a corresponding grayscaled character rig. The defensive unit is also represented accordingly. Said grayscaled character rigs are set with standard humanoid skeleton heirarchy structure and designated with material identfiers for areas that shaders, at run time, exclude for compositing, such as the character face and skin colors. Other metrics integrated with the characters include real-life height and weight estimates to provide visual fidelity in the animation's scaled environment, which is set at 1 unit=1 meter. Collider features are assigned to certain bones for collision absorption effects. While most of the animations are driven by mapping motion data from marker-based and markerless systems, as well as some manual keyframe-by-keyframe methods, occlusion errors are mostly fixed manually, to the granular level of adjusting respective z-values. Said grayscale character rigs feature an average of 100 bones weighted with 3 to 4 bones per vertex for realistic deformation supported by hybrid kinematic settings of 1 for forward kinematics applied the to upper body, and a setting of 1 for inverse kinematics applied to the lower body. To prevent skating or floating effects of the grayscale character rigs, and without the use of raycasting, necessary ground detection is addressed by featuring baked shadows on the feet areas along with the necessary Inverse Kinematic setting of 1 which help in providing grounding effects, visually and spatially.

The respective clothing mesh/uniform mesh per character rig is created separately with the skeletal armature properties of the base character (grayscale character rig) copied to the skeletal properties of the clothing/uniform mesh or, more accurately, used by the clothing/uniform mesh to ensure that when the grayscale character animates, the clothing/uniform mesh is in sync with the character's body. The respective clothing/uniform mesh is identified by specific identifiers, naming conventions, or structured data types, and contained in GLB file format to manage their attachment and animation synchronization during runtime. The set of clothing/uniform meshes mapped with respective grayscale character rigs are transposable with various team designs and varieties are provided in setup.

The respective helmet, likewise, is separately created, but instead of transferring the skeletal armature properties of the base character, the respective helmet, since it is rigid, is parented to the respective head bone of the base character for synchronization at run time. Since it is rigid, it is assigned a vertex weight setting of 1 to the relevant bone.

The shoulder pads are created and represented by separate bones parented to the respective base character's clavicle bone for realistic and synchronized movement with the said character. The polygon budget for said uniform meshes per character is estimated at 1000 polygons and exported in the GLB file format. The football is created as a static mesh and retargeted with mocap data from a rendering video and integrated into the gameplay animation. The football can also be created manually with a frame-by-frame process.

A scaled 3D static image depicting a full-length football field serves as the pre-rendered static background and the main layer for the pre-rendered overlays. Said image is rendered as a static 3d image using the WebP file format and features transparent end zones for automatic customization during game session setup upon team selection. As the base layer during compositing with the gameplay and assets, when a gameplay involves either positive or negative yardage, parallax scrolling is calibrated and implemented to effect with appropriate movement of said gameplay over the background in either direction, in accordance to the game state. Using time-based-animation technique by calibrating time settings within the browser method (requestAnimationFrame) with parallax scrolling, movements of the pre-rendered static background, can be adjusted to produce scaled realistic movements. Additionally, when a gameplay is called, the game logic translates the current field position into the respective x, y pixel coordinates of said static background for proper coordination and positioning of the current gameplay's starting position on said static background. The reusable static field background is maintained in browser cache.

Customization of voice over play-by-play narration is available during game setup with a Text-To-Speech setup through integrated VibeVoice text-to-speech api, an open source application. The process entails entry of Name Assignments, for characters that represent ball-handling positions, which are processed as JSON data formatted string variables and injected for text-to-speech content assembly via Javascript to align with respective play-by-play narration, and converted to Text-to-Speech audio via VibeVoice endpoint api, (a part of the VibeVoice suite), and synchronized with gameplay animation at runtime using Web Audio api.

Said video game leverages certain rules of American football in optimizing game processes involving Memory Leak Prevention, Utilization of Single-Use Animation Files, and Idle-Time Management that address computing resource efficiency.

As in any given game of American football, while teams run a limited playbook, the play by play dynamics involved in the intersection of all the players, effect into a unique gameplay. In mimicking such environment, said game, with support from an ever-expanding library of WebM pre-rendered gameplay animations, functions with single-use WebM pre-rendered animation files. Such operation also serves as a step in preventing any occurrence of memory leak by leveraging post-playback deletion of animation files and related data from RAM memory. However, as the browser, by default, automatically saves a copy in the browser cache in advance, accumulation of data in the browser cache can contribute to an occurrence(s) of memory leak(s). To mitigate, a no-store directive is implemented during the file download to prevent unnecessary storage in the browser cache, a step in preventing memory leaks. Another preventive measure is through the use of Javascript structures, Weakset and Weakmap, to hold references that are automatically deleted by the browser more efficiently than manual deletion/garbage collection. Weakmap provides key-value pair function, while Weakset provides variable functions for non string values. Respectively, as used in said game, the pixel coordinates of the static background referenced for positioning the pre-rendered animation over the static background are stored as Weakmap data, while the static background's references are stored as Weakset variables. After each playback cycle, the Weakset and Weakmap references are cleared to prevent data accumulation, while the reusable object such as the static 3D football field background is cached for reuse, saving on garbage collection overhead.

Other memory management methods include Object Pooling wherein objects such as the uniform meshes, which are reusable in the game loop cycle, are simply hidden in the Object Pool when not in use. Its EventListeners are cleared, and just requiring a reset of their properties, without the need to reload the uniform mesh file, saving overhead. Nullifying related variables prevent unnecessary references to inactive elements and objects that can cause data accumulation

When raw data of game assets, including the animation, are collectively represented as Binary Large Object when loading to RAM memory for compositing, a Binary Large Object url (blob url) is created as its playable url. As this url references much data that can contribute to memory leaks, revocation of the blob url after the Binary Large Object is fully loaded, is another step taken to prevent memory leaks

As said game is event driven with single-use files that are cleared after its use and wherein preload involving gameplay animations is not an option, said game is optimized for on-demand loading function. On demand loading speeds up initial page load, minimizes memory usage by only loading assets into GPU memory when needed, and optimizes bandwidth. However, there is the performance trade-off of possible latency issue, even if only in the hundreds of milliseconds, that can disrupt seamless transition from displaying the static MCQ panel to playback of the next gameplay animation. To mitigate, during the event that a gameplay animation is triggered, said game maintains the MCQ panel, which is rendered on static html/css with a z-index of 2, and calls up the video element from the object pool, and positions behind the MCQ display, with a z-index of 1. Upon start of stream, CSS opacity is adjusted to transition and fade out the MCQ image panel.

While average NFL gameplay is about 5 to 8 seconds, said Game's parameter estimation high-budgets its average gameplay with an average duration of 10 seconds, for the purpose of adding contingency buffer. or protective estimate. In combining the function of displaying the static 40-second MCQ prompts of said game, aimed to mimic the NFL's 40-second play clock, it effects a 4:1 Idle:Playback distribution ratio that optimizes its cpu/gpu usage. For 40 seconds of every 50-second cycle, user's/users' GPU would be virtually idle (0-2% usage) as it only needs to display a static or background depicting MCQ questions. In this scenario, where the GPU is mostly idle (involved with the static display), the CPU manages a single-threaded calculation of game logic and using a single core engaged for the game logic calculations. As a result of the mostly idle Power Srate, The GPU will likely downclock its speed and run in a low-power state.

While standard media streaming like streaming a youtube video uses the least cpu/gpu resources as compared to playing games that require real-time rendering, as well as streaming pre-rendered webm animations that require run-time-compositing, said video game, played for 1 hour (session of 4 15-minute quarters), when compared to a youtube stream of 1 hour with identical parameters relating to resolution, bit rate, and fps, the cpu/gpu savings favor said video game due to approximate 48-minute idle time/12 minute playback time compared to the youtube continuous stream of 60 minutes. With identical hardware acceleration involved, though the 10-second playback of said game would likely use more GPU resources during the video decoding process than the straightforward 2d stream of a youtube video of identical duration, the cpu/gpu savings overall could potentially be more than 50%, stemming from the approximate 80% idle state.

As used herein, the term ‘idle state’ refers to an operational mode of the graphics processing unit (GPU) characterized by a reduction in power consumption, clock speed, or processing throughput relative to an active rendering state. In one embodiment, the ‘idle state’ comprises a low-power sleep state where frame rendering is temporarily suspended or bypassed. In another embodiment, the ‘idle state’ comprises a clock-gated or power-gated state where specific execution units of the GPU are deactivated while video memory remains refreshed. In yet another embodiment, the ‘idle state’ comprises a static rendering mode where the GPU maintains a single, previously rendered frame buffer on a display device without executing active fragment or vertex shading updates, thereby allowing game logic to execute exclusively on the CPU without visible disruption to the user interface.

A web-based game played online runs in a browser, requiring internet for assets, server interaction, and multiplayer features. Conversely, the same game locally installed with a framework named Electron enables web-based applications to operate offline. Electron is a packaged, desktop-installed framework that provides a Web Host Environment that operates entirely offline, using local files for faster loading, native system access, and no server dependency.

FIGS. 3 to 5 shows the system flowchart of said video game with characteristics as available in an online state within a web browser, and in an offline state wherein a web host environment, such as the Electron Framework, is bundled with the game application.

If said video game is played online 41 with multiple users 43 remotely, 44 said video game is configured and synchronized for multiple players users with a session ID number. If said video game is played by a single user against the computer, said video game is configured for single user 45 with a session ID number. If said video game is played offline with multiple users 42, said video game is configured for multiple users 46 without session ID required. If said video game is played by a single user offline 45, said video game is configured for a single user without a session ID required.

A Subject Category is then selected for configuration with the MCQ multiple choice question format 47, of said video game. If said video game is played by a single user 48, a Difficulty Level is required for further configuration 49. A static panel with selection buttons associated with respective teams and uniforms is displayed on an html/css static renderer for further selection setup 50.

The next step in setup involves assignment or selection of respective user's/Users' input device(s) 51. If said video game is configured for Online configuration 52 with multiple users 53, locally, on one computing device 54, assignment and configuration setup by each user after joining session may include USB-connected input device or Wireless input device 56. If said video game is configured for Online configuration 52 with multiple users 53, remotely, 54, assignment and configuration setup by each user after joining session may include USB-connected input device, Wireless input device, or computer keyboard 55. If said video game is configured for Online configuration involving a single user session, assignment and configuration setup may include USB-connected input device, Wireless input device, or computer keyboard 55.

If said video game is configured for Offline configuration involving multiple users 57, assignment and configuration setup may include USB-connected input device or Wireless input device 56. If said video game is configured for Offline configuration involving a single user 57, assignment and configuration setup may include USB-connected input device, Wireless input device, or computer keyboard 55.

A persistent on-screen button is made available for exit.

The next step involves displaying, via html/css static renderer, a panel with selection controls for Team/Uniform mesh selection 58, with respective end zone designs, and input boxes for Name assignments, as JSON data 59, for the grayscale 3d character rigs that represent positions associated with ball-handling facilitation and maintained in Active RAM memory 60. The JSON data representing the name assignments are loaded and maintained in browser default local storage 61. The panel used for the team/clothing uniform mesh selection and JSON data input is Cleared and unreferenced, and a persistent on-screen button is made available for recalling setup.

The reusable Static 3D Football Field background image is loaded to and maintained in browser cache 62.

Game logic determines game state for defining an associated algorithm with initial MCQ function 63. An MCQ panel is displayed 64, via html/css static renderer with 4 questions, each with respective key response and 3 distractors based on selected subject category. During the predetermined idle interval (the 40-second window while the multiple choice question MCQ panel is displayed), the GPU enters an idle state because the visual interface requires no active 3D rendering or frame rate updates. Concurrently, the CPU executes game logic on a single-threaded process. This single-threaded CPU logic comprises background tasks including, but not limited to: running a countdown timer associated with the multiple choice questions, monitoring user input interfaces for the selection of the answers, processing background audio threads, and pre-loading asset data from a storage medium into memory for the subsequent game state. By shifting these lightweight operational tasks entirely to a single CPU thread and idling the GPU, system power consumption is drastically reduced during the user decision phase without lagging or disrupting the presentation of the questions. MCQ algorithm calculates MCQ scores 65 from respective MCQ responses upon expiration of predetermined idle interval.

Game logic determines a gameplay 66. With animation file identified, a corresponding Control cache: no-store directive is implemented 67, for preventing unnecessary caching of the WebM file intended as a single-use file, along with usage of Weakmap to store parallax scrolling references associated with the 3D static football field background, as well as usage of Weakset storing object reference to the single-use WebM animation for automatic garbage collection, or clean up for memory leak prevention after usage in playback. The identified WebM animation file is retrieved for loading and compositing with other game assets in system RAM 68 as raw Binary Large Object. Said video game assets involved include the Webm file for single use, retrieved from the library of said video game, the static 3D football field background which is retrieved from the browser cache, the uniform mesh from its respective glb file from the object pool, and a Javascript command retrieves the JSON data representing the associated TTS text from the browser's local default storage, and injects said JSON data holding the name assignments for assembly into associated text-to-speech file representing the play-by-play narrative voice-over.

A Binary Large Object url (blob url) is created 69, as its playable url. Said Binary Large Object, or blob, containing said game assets are decoded, and composited via WebGL in system RAM 70. Microsoft VibeVoice endpoint api converts the text-to-speech text into an audio file. The WebM file containing the respective grayscale character rigs mapped and composited via WebGL with respective clothing/uniform meshes, with the separate base layer represented by the 3d static football field image are synchronized for playback with the converted audio file synchronized with the animation video via Web Audio api.

With no pre-loading directive associated with the single-use function of the pre-rendered WebM file, in case of resulting latency involved in play back, the video element is called from the Object Pool, but positioned behind the MCQ panel 71. The MCQ panel, with association with the css opacity property, is coded to fade as the pre-rendered WebM file streams 72.

Upon expiration of the predetermined idle interval, the single-threaded CPU process transitions from an input-monitoring state to a score-processing state. The CPU processes the user selection to generate a raw total points score via the video game's algorithm. To optimize system resources and continue the energy-efficient cycle, the CPU does not initiate a real-time, resource-intensive 3D graphic rendering engine sequence. Instead, the CPU uses the mcq raw total points score converted into game metrics by the video game's game logic as an index or trigger key to call a specific, matching pre-rendered gameplay animation asset from a non-transitory computer-readable storage medium or server repository. Once retrieved, the CPU transitions the GPU out of the low-power idle state back into an active media playback state. The GPU then plays back the pre-rendered gameplay animation on the display device for a duration of approximately 10 seconds to visually depict the user's/users' score performance. Because the animation is pre-rendered, the GPU minimizes vertex and shader processing spikes during the wake-up transition, thereby smoothing the power curve of the computing system while providing continuous, uninterrupted visual gameplay reinforcement to the user.

The MCQ panel is then returned to the Object Pool 73, unreferenced and its properties reset and its Event Listeners deleted. The revocation of the Binary Large Object url (blob url) is implemented as a memory-leak-prevention step 74. When the playback of the pre-rendered WebM gameplay animation concludes 75, the pre-rendered WebM file is deleted and unreferenced and its EventListeners cleared, the video element is returned to the Object Pool, its EventListeners cleared, its properties reset 76. The Cleanup Process or manual Garbage Collection 77 is implemented to reclaim memory not reclaimed by automatic Garbage Collection by clearing all EventListeners, detaching references to all non-reusable objects, nullifying global variable(s), and clearing all Time Intervals and TimeOuts, and deactivating Callbacks, while returning and maintaining objects such as the clothing/uniform mesh file in the Object Pool, with their properties reset, and also their EventListeners cleared. The 3d field background is returned to the browser cache, unreferenced and its EventListeners cleared.

If there is time remaining in the current quarter 78, the game loop resumes to the Game Logic to determine game state (item 63 in FIG. 4). If no time remains in the current Quarter and time remains in the Game Clock 79, the game loop resumes to the Game Logic to determine game state (item 63 in FIG. 4). If time has expired in the current Quarter and the Game Clock 79, the end of Regulation Period 80, has been reached. If the game score is tied 81, the game loop resumes to the Game Logic to determine game state (item 63 in FIG. 4). If the game score is not tied, the game session is over. In the event of an overtime, the game logic resumes with the coin toss mcq 1, and a full 15-minute quarter is played. If game is not tied after the overtime quarter, the game is over, otherwise, the game loop recycles.

### BEST MODE OF IMPLEMENTATION

### Server System Requirements

CPU 64 bit
2 GB Graphics card
Multi Core processor
16 GB Ram
Microsoft Dot Net Framework
GLB file viewer
Rendering Software (3ds max)
   Below are added Open-source software required for system development and operation:
FFmpeg, an Open-source code platform for handling and encoding of media and multimedia data.
FFmpeg is required for system development
FFmpeg is licensed under GNU Lesser General Public License (LGPL)
VibeVoice, an Open-source Text-To-Speech application,
   VibeVoice is required in system operation
   VibeVoice is licensed under the MIT license

What is claimed is:

1. A computer-implemented method for generating interactive football gameplay on a computing system comprising a central processing unit (CPU) and a graphics processing unit (GPU), the method comprising:
maintaining an ever-expanding digital library in a server repository, of pre-rendered animated football gameplays with straight alpha channels featuring grayscale characters for compositing with user-selected clothing mesh mapped to associated said grayscale characters at runtime;
maintaining an ever-expanding library in a server repository, of clothing meshes mapped to said grayscale characters, and contained in glb file format;
updating, via a processor, said ever-expanding digital library with football gameplay animations that are pre-rendered;
updating, via a processor, said ever-expanding library of clothing meshes mapped to said grayscale characters;
indexing of said pre-animated gameplays associated with yardage numbers, translated from game metrics, that drives the event of retrieval of specific pre-rendered gameplay animation from said library for playback as a game scene in a client system;
receiving, via user interface, a signal indicating a selected number of players;
receiving, via user interface, a signal specifying a subject category, adjusting query parameters, to retrieve sets of questions associated with specified subject category;
receiving via a processor, user input specifying controlling device for mapping game input from respective user/users;
identifying with a unique identifier associated with a selected specific skeletal mesh and loading its associated clothing mesh file into respective user active ram memory. for subsequent runtime compositing;
receiving via user interface and loading to default local storage, name assignment(s) in json data format placeholders for runtime injection into associated TTS text for audio conversion and synchronization with associated animation at runtime;
loading scaled 3D static background image of full-length football field contained in WebP file format, from a server repository, to user's/users' browser cache for subsequent cyclical runtime compositing;
displaying a dynamic panel containing objective queries each composed of a stem and options and a key and requiring engagement via a user interface;
receiving user input in response to objective queries, assessing user's/users' responses by factoring parameters that include correctness, completeness, and promptitude, arriving with raw points total and resulting point margin by the cpu that is mapped to game metrics of said game that updates said video game's game state accordingly, triggering the state of retrieving from a storage medium the specific pre-rendered gameplay animation and associated game assets as Binary Large Object into a buffer in system RAM for compositing and subsequent playback of composited pre-rendered gameplay animation to depict updated game state;
creating via a processor a Binary Large Object url as playable url for direct In-Memory access to binary data of said Binary Large Object enabling playback via a video element;
mitigating any latency effect by maintaining display of said dynamic panel containing objective queries with a gradual elimination of its opacity for visual blending of playback by said video element layered under said panel;
revoking said Binary Large Object url when said Binary Large Object has been fully composited as a memory leak prevention step;
reclaiming memory from the inactive game assets released at end of each playback cycle, clearing EventListeners, and detaching references to reusable objects and assets including the video element and the clothing meshes, and resetting their properties as they are returned to the object pool to trigger data garbage collection process;
determining game state for either game loop continuation or game termination.

2. The method of claim 1, wherein said pre-rendered gameplay animation is a single-use file for preventing memory leaks comprising:
purging each single-use file after playback;
implementing Cache control: no-store directive, wherein the browser default-action of automatically saving a copy of loaded files in the browser cache is prevented, adding a step towards unnecessary accumulation of data in the browser cache;
implementing a directive of removing event listeners related to said single-use files, and non-reusable files wherein event handler(s) from the related objects are detached, enabling browser clean-up, preventing unnecessary accumulation of data in RAM cache;
implementing processor configured to execute a JavaScript function to clear time-related functions of said single-use files, which would continue running in the background if not cleared, preventing unnecessary functions and accumulation of data in RAM cache;
nullifying key-to-value pairs such as parallax scrolling properties of said 3D static background;
implementing processor configured to execute a JavaScript function for referencing objects for facilitation of automatic detachment of related references of said objects upon conclusion of each playback cycle;
revoking Binary Large Object url after loading of said single-use files and accompanying game assets in RAM memory.

3. The method of claim 1, further comprising:
object pooling of key objects of said video game that include clothing mesh glb files, 3D background, and dynamic panels for efficient reuse, eliminating the cost of frequent memory allocation and data garbage collection, and reducing in-memory fragmentation;
returning an inactive object from the object pool instead of instantiating a new object;
resetting, via a processor, the properties of pooled objects to default values;
detaching references to said key pooled objects.

4. The method of claim 1, further comprising:
periodically reducing usage and downclocking of GPU speed to an idle state for a predetermined idle interval while said dynamic panel containing objective queries is presented;
executing game logic on a single-threaded process of the CPU on a single core during the predetermined idle interval, wherein the GPU and CPU activity is controlled to optimize energy efficiency without interrupting the user experience.

5. The method of claim 4, further comprising:
pausing gpu activity for approximately 40 seconds, mimicking real life football's 40 second play clock with the game's MCQ game state within the cyclical interval time of approximately 50 seconds, wherein video element playback time is approximately up to 10 seconds, mimicking football's average gameplay duration, this 4:1 ratio of gpu idle time to the video element playback time effects with a downclocking of gpu speed and running in a low-power state predominantly per said cycle.

6. The method of claim 1, comprising:
maintaining an expandable digital library of educational content represented in objective assessment structure, whereby said educational content is represented accordingly in respective categories of varying educational levels;
updating periodically, via a processor, said digital library of educational content;
receiving, via a user interface, a signal selecting an educational subject category.

7. The method of claim 1, wherein the parameters of the pre-rendered animation files comprise a resolution of about 720p, a bitrate of about 4 mbps, and a frame rate of about 60 fps, with straight alpha channels, with a duration of about 10 seconds, contained in a WebM file format.

8. A computing system for generating interactive football gameplay, the system comprising:
a display device;
a non-transitory computer-readable storage medium configured to store asset data;
a graphics processing unit (GPU) coupled to the display device; and
a central processing unit (CPU) coupled to the GPU and the storage medium,
wherein the CPU and the GPU are configured to:
maintain an ever-expanding digital library in a server repository, of pre-rendered animated football gameplays with straight alpha channels featuring grayscale characters for compositing with user-selected clothing mesh mapped to associated said grayscale characters at runtime;
maintain an ever-expanding library in a server repository, of clothing meshes mapped to said grayscale characters, and contained in glb file format;
update, via a processor, said ever-expanding digital library with football gameplay animations that are pre-rendered;
update, via a processor, said ever-expanding library of clothing meshes mapped to said grayscale characters;
index of said pre-animated gameplays associated with yardage numbers, translated from game metrics, that drives the event of retrieval of specific pre-rendered gameplay animation from said library for playback as a game scene in a client system;
receive, via user interface, a signal indicating a selected number of players;
receive, via user interface, a signal specifying a subject category, adjusting query parameters, to retrieve sets of questions associated with specified subject category;
receive via a processor, user input specifying controlling device for mapping game input from respective user/users;
identify with a unique identifier associated with a selected specific skeletal mesh and loading its associated clothing mesh file into respective user active ram memory, for subsequent runtime compositing;
receive via user interface and loading to default local storage, name assignment(s) in json data format placeholders for runtime injection into associated TTS text for audio conversion and synchronization with associated animation at runtime;
load scaled 3D static background image of full-length football field contained in WebP file format, from a server repository, to user's/users' browser cache for subsequent cyclical runtime compositing;
display a dynamic panel containing objective queries each composed of a stem and options and a key and requiring engagement via a user interface;
receive user input in response to objective queries, assessing user's/users' responses by factoring parameters that include correctness, completeness, and promptitude, arriving with raw points total and resulting point margin by the cpu that is mapped to game metrics of said game that updates said video game's game state accordingly, triggering the state of retrieving from a storage medium the specific pre-rendered gameplay animation and associated game assets as Binary Large Object into a buffer in system RAM for compositing and subsequent playback of composited pre-rendered gameplay animation to depict updated game state;
create via a processor a Binary Large Object url as playable url for direct In-Memory access to binary data of said Binary Large Object enabling playback via a video element;
mitigate any latency effect by maintaining display of said dynamic panel containing objective queries with a gradual elimination of its opacity for visual blending of playback by said video element layered under said panel;
revoke said Binary Large Object url when said Binary Large Object has been fully composited as a memory leak prevention step;
reclaim memory from the inactive game assets released at end of each playback cycle, clearing EventListeners, and detaching references to reusable objects and assets including the video element and the clothing meshes, and resetting their properties as they are returned to the object pool to trigger data garbage collection process;
determine game state for either game loop continuation or game termination.

9. The system of claim 8, wherein said pre-rendered gameplay animation is a single-use file for preventing memory leaks, wherein the CPU and the GPU are configured to:
purge each single-use file after playback;
implement Cache control: no-store directive, wherein the browser default-action of automatically saving a copy of loaded files in the browser cache is prevented, adding a step towards unnecessary accumulation of data in the browser cache;
implement a directive of removing event listeners related to said single-use files, and non-reusable files wherein event handler(s) from the related objects are detached, enabling browser clean-up, preventing unnecessary accumulation of data in RAM cache;
implement processor configured to execute a JavaScript function to clear time-related functions of said single-use files, which would continue running in the background if not cleared, preventing unnecessary functions and accumulation of data in RAM cache;
nullify key-to-value pairs such as parallax scrolling properties of said 3D static background;
implement processor configured to execute a JavaScript function for referencing objects for facilitation of automatic detachment of related references of said objects upon conclusion of each playback cycle;
revoke Binary Large Object url after loading of said single-use files and accompanying game assets in RAM memory.

10. The system of claim 8, wherein the CPU and the GPU are configured to:
object pool of key objects of said video game that include clothing mesh glb files, 3D background, and dynamic panels for efficient reuse, eliminating the cost of frequent memory allocation and data garbage collection, and reducing in-memory fragmentation;
return an inactive object from the object pool instead of instantiating a new object;
reset, via a processor, the properties of pooled objects to default values;
detach references to said key pooled objects.

11. The system of claim 8, wherein the CPU and the GPU are configured to:
periodically reduce usage and downclocking of GPU speed to an idle state for a predetermined idle interval while said dynamic panel containing objective queries is presented;
execute game logic on a single-threaded process of the CPU on a single core during the predetermined idle interval, wherein the GPU and CPU activity is controlled to optimize energy efficiency without interrupting the user experience.

12. The system of claim 11, wherein the CPU and the GPU are configured to:
pause gpu activity for approximately 40 seconds, mimicking real life football's 40 second play clock with the video game's MCQ game state within the cyclical interval time of approximately 50 seconds, wherein video element playback time is approximately up to 10 seconds, mimicking football's average gameplay duration, this 4:1 ratio of gpu idle time to the video element playback time effects with a downclocking of gpu speed and running in a low-power state predominantly per said cycle.

13. The system of claim 8, wherein the CPU and the GPU are configured to:
maintain an expandable digital library of educational content represented in objective assessment structure, whereby said educational content is represented accordingly in respective categories of varying educational levels;
update periodically, via a processor, said digital library of educational content;
receive, via a user interface, a signal selecting an educational subject category.

14. The system of claim 8, wherein the parameters of the pre-rendered animation files comprise a resolution of about 720p, a bitrate of about 4 mbps, and a frame rate of about 60 fps, with straight alpha channels, with a duration of about 10 seconds, contained in a WebM file format.
